(19) United States
(12) Patent Application Publication
(10) Pub. No.: US 2011/0234568 A1
(43) Pub. Date: Sep. 29, 2011

(54) DISPLAY DEVICE

(75) Inventors: Takeshi IZUMIDA, Mobara (JP); Kenta Kajiyama, Yotsukaido (JP); Naoki Tokuda, Mobara (JP); Yasuharu Yatsu, Chiba (JP); Noriyuki Shikina, Ichihara (JP)

(73) Assignees: Hitachi Displays, Ltd.; Canon Kabushiki Kaisha

(21) Appl. No.: 13/050,975

(22) Filed: Mar. 18, 2011

(30) Foreign Application Priority Data
Mar. 24, 2010 (JP) 2010-068400

(51) Int. Cl. G06F 3/038

(52) U.S. Cl. 345/211

(57) ABSTRACT

A display device includes: scanning lines for selecting a group of pixels out of pixels; control lines to which a pulse signal is supplied to control selection of at least one of the plurality of scanning lines to which a scanning signal is input; a scanning circuit which includes transistors controlled with the pulse signal, the scanning circuit being connected to the plurality of scanning lines and being disposed outside a display area; and a conductive mesh including conductive wires running in intersecting directions. The conductive mesh is placed above the transistors and the plurality of scanning lines except the display area. Above the plurality of scanning lines, the plurality of conductive wires constituting the conductive mesh intersect each other three-dimensionally in a manner that does not make the plurality of conductive wires parallel to the plurality of scanning lines.

### CROSS-REFERENCE TO RELATED APPLICATION

The present application claims priority from Japanese application JP 2010-068400 filed on Mar. 24, 2010, the content of which is hereby incorporated by reference into this application.

### BACKGROUND OF THE INVENTION

1. Field of the Invention

The present invention relates to a display device.

2. Description of the Related Art

Display devices such as liquid crystal display devices and organic electroluminescence display devices are driven generally by a matrix method. In the matrix method, a plurality of data lines and a plurality of scanning lines run in intersecting directions. When a scanning signal is input in one of the scanning lines, this scanning line is selected and a signal is applied to a pixel that is associated with the selected scanning line from a relevant data line.

A scanning signal is generated in a scanning circuit, and forming a scanning circuit on a substrate from a thin film is a known practice. A scanning circuit usually includes a shift register, which (particularly one constituted of a thin-film transistor) is susceptible to static electricity. A known way to protect a shift register in a scanning circuit from static electricity is to provide a shielding layer, which is connected to a ground potential, above the scanning circuit (see JP 2009-27123 A).

Forming the shielding layer forms a parasitic capacitance between wiring and the shielding layer. The resultant problem is a delay of a signal that travels through the wiring covered with the shielding layer, which impairs the operational stability of the scanning circuit.

### SUMMARY OF THE INVENTION

An object of the present invention is to provide a display device that has both the operational stability of a scanning circuit and a countermeasure against static electricity.

(1) A display device according to the present invention includes: a display area which includes a plurality of pixels; a plurality of data lines for supplying a data signal to the plurality of pixels; a plurality of scanning lines to which a scanning signal for selecting a group of pixels out of the plurality of pixels is input; control lines to which a pulse signal is supplied to select one of the plurality of scanning lines to which the scanning signal is input; a scanning circuit which includes transistors controlled with the pulse signal, the scanning circuit being connected to the plurality of scanning lines and being disposed outside the display area; and a conductive mesh including a plurality of conductive wires running in intersecting directions to have a plurality of intersections, in which the conductive mesh is placed above the transistors and the plurality of scanning lines except the display area, under a state in which the conductive mesh is electrically insulated from the transistors and the plurality of scanning lines, and in which, above the plurality of scanning lines, the plurality of conductive wires constituting the conductive mesh intersect each other three-dimensionally in a manner that does not make the plurality of conductive wires parallel to the plurality of scanning lines. According to the present invention, a countermeasure against static electricity is taken by placing the conductive mesh above the transistors and the scanning lines, and the operational stability of the scanning circuit is also accomplished because the conductive wires are not parallel to the scanning lines to keep the parasitic capacitance small.

(2) In the display device as described in Item (1), the conductive mesh may include a portion that is located above the control lines and that is electrically insulated from the control lines, and, in the portion, an interval between every two of the plurality of intersections of the plurality of conductive wires, the every two of the plurality of intersections being adjacent to each other in a direction orthogonal to the plurality of scanning lines, may be wider than in portions of the conductive mesh that are located above the transistors and above the plurality of scanning lines.

(3) In the display device as described in Item (1) or Item (2), at a portion of the conductive mesh that is located above the plurality of scanning lines, an integer multiple of an interval between every two of the plurality of intersections of the plurality of conductive wires, the every two of the plurality of intersections being adjacent to each other in a direction orthogonal to the plurality of scanning lines, may be equal to a pitch between every two of the plurality of pixels that are adjacent to each other.

(4) In the display device as described in any one of Items (1) to (3), the display device may be an organic electroluminescence display device, the display device may further include a pixel electrode disposed in each of the plurality of pixels, and the conductive mesh may be formed on the same layer level as the pixel electrode.

### BRIEF DESCRIPTION OF THE DRAWINGS

In the accompanying drawings:

FIG. 1 is a plan view illustrating a display device according to an embodiment of the present invention;

FIG. 2 is a vertical sectional view of the display device of FIG. 1;

FIG. 3 is a partial enlarged view of a scanning circuit; and

FIG. 4 is a vertical sectional view illustrating a modification example of the display device of FIG. 2.

### DETAILED DESCRIPTION OF THE INVENTION

An embodiment of the present invention is described below with reference to the drawings.

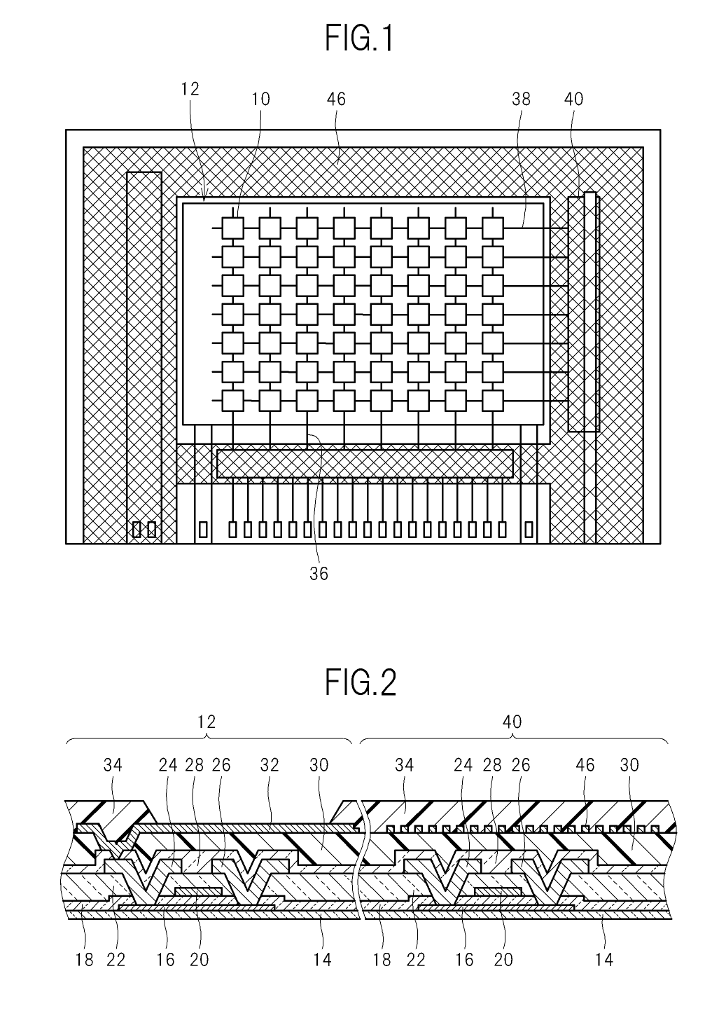

FIG. 1 is a plan view illustrating a display device according to the embodiment of the present invention. FIG. 2 is a vertical sectional view of the display device of FIG. 1. The display device in this embodiment is an organic electroluminescence display device. However, the present invention is also applicable to a liquid crystal display device.

As illustrated in FIG. 1, the display device has a display area 12 in which a plurality of pixels 10 are arranged. The pixels 10 are each provided with a transistor, for example, a thin-film transistor. To give a more detailed description with reference to FIG. 2, a semiconductor layer 16 (e.g., a polysilicon layer) is formed on a substrate 14 (e.g., a glass substrate). Agate insulating film 18 (e.g., a silicon oxide film) is formed on the semiconductor layer 16. A gate electrode 20 is disposed on the gate insulating film 18. The gate electrode 20 is covered with a first insulating film 22 (e.g., a silicon oxide film). A source electrode 24 and a drain electrode 26 are formed to be electrically connected to the semiconductor layer 16 via through holes formed in the first insulating film 22 and the gate insulating film 18. The source electrode 24 and the drain electrode 26 are covered with a second insulating film 28 (e.g., a silicon nitride film). A third insulating film 30 (e.g., an organic film) is further layered on top of the second insulating film 28. The top face of the third insulating film 30 has a higher degree of levelness than the top face of the second insulating film 28. A pixel electrode 32 (e.g., an anode electrode) is disposed on the third insulating film 30 to be electrically connected to one of the source electrode 24 and the drain electrode 26 via a through hole formed in the second insulating film 28 and the third insulating film 30. A bank 34 is provided on the third insulating film 30 so as to surround a central portion of the pixel electrode 32. A not-shown light emitting layer is placed on the pixel electrode 32 in the region surrounded by the bank 34, and a not-shown common electrode (e.g., a cathode electrode) is disposed on the light emitting layer.

As illustrated in FIG. 1, the display device includes a plurality of data lines 36 for supplying a data signal to the plurality of pixels 10. The display device also includes a plurality of scanning lines 38 for selecting a group of pixels 10 out of the plurality of pixels 10. A scanning circuit 40 is formed outside the display area 12 to be connected to the scanning lines 38.

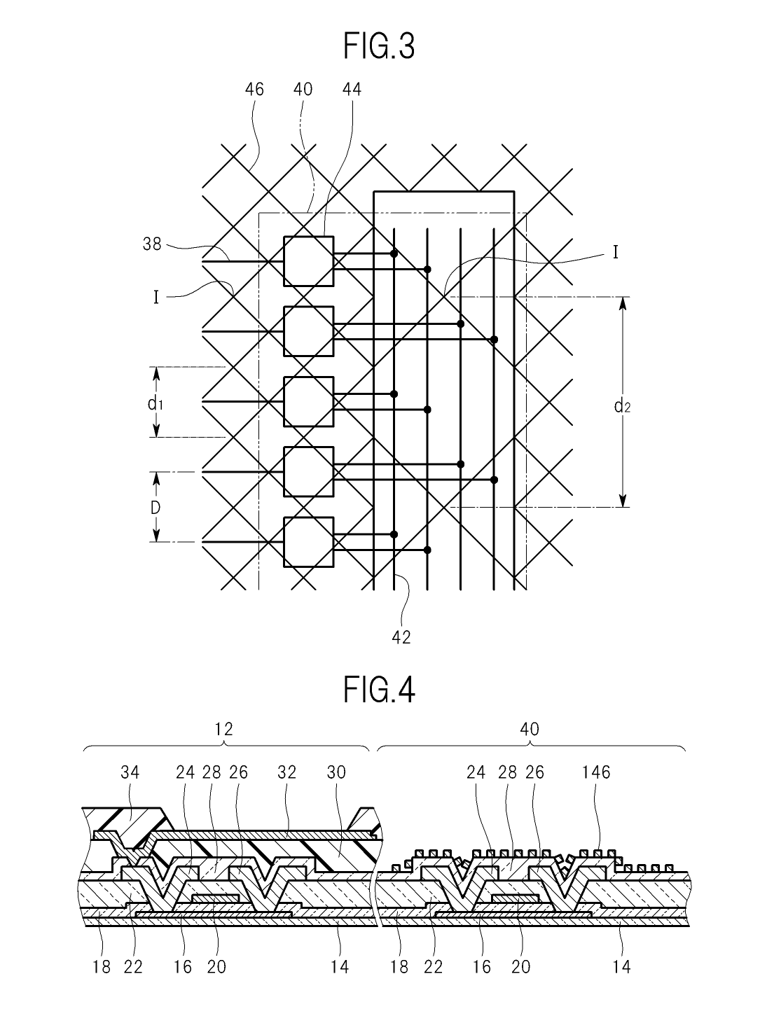

FIG. 3 is a partial enlarged view of the scanning circuit 40. The scanning circuit 40 generates a scanning signal and selects at least one scanning line 38 to which the scanning signal is input. This selection is controlled with the use of a pulse signal (a clock signal, for example) input to the scanning circuit 40. The pulse signal is supplied through control lines 42.

The scanning circuit 40 includes a plurality of flip-flops 44. The flip-flops 44 include thin-film transistors controlled with a pulse signal (a clock signal, for example). To give a more detailed description with reference to FIG. 2, the semiconductor layer 16 (e.g., a polysilicon layer) is formed on the substrate 14 (e.g., a glass substrate). The gate insulating film 18 (e.g., a silicon oxide film) is formed on the semiconductor layer 16. The gate electrode 20 is disposed on the gate insulating film 18. The gate electrode 20 is covered with the first insulating film 22 (e.g., a silicon oxide film). The source electrode 24 and the drain electrode 26 are formed to be electrically connected to the semiconductor layer 16 via through holes formed in the first insulating film 22 and the gate insulating film 18. The source electrode 24 and the drain electrode 26 are covered with the second insulating film 28 (e.g., a silicon nitride film). The third insulating film 30 (e.g., an organic film) is further layered on top of the second insulating film 28. The top face of the third insulating film 30 has a higher degree of levelness than the top face of the second insulating film 28.

A conductive mesh 46 is formed on the third insulating film 30. The conductive mesh 46 is formed on the same layer level as the pixel electrode 32. For example, the conductive mesh 46 and the pixel electrode 32 are formed at once by the same process (a process that includes forming an etching resist through photolithography and performing etching with the resist as a mask) from the same conductive film.

As illustrated in FIG. 1 or FIG. 3, the conductive mesh 46 includes a plurality of conductive wires running in intersecting directions to have a plurality of intersections I. The conductive mesh 46 is disposed to stretch in the intersecting directions of the conductive wires. The conductive mesh 46 is electrically insulated from the thin-film transistors (a part of the flip-flops 44) and the plurality of scanning lines 38. The conductive mesh 46 is placed above the thin-film transistors (a part of the flip-flops 44) and the scanning lines 38 except the region where the pixels 10 are located. The conductive wires constituting the conductive mesh 46 intersect each other three-dimensionally so as not to be parallel to the scanning lines 38 above the scanning lines 38. The conductive mesh 46 is preferred to be connected to one of a power source potential of the display device, a reference potential, and a ground potential.

As illustrated in FIG. 3, the conductive mesh 46 is formed, in plan view, in a region where the scanning lines 38 are disposed and a region where the control lines 42 are disposed. However, the conductive mesh 46 is electrically insulated from the scanning lines 38 and the control lines 42 because of the insulating film interposed between the conductive mesh 46 and the scanning lines 38 and between the conductive mesh 46 and the control lines 42.

The conductive mesh 46 is disposed such that, in a portion of the conductive mesh 46 that is located above the scanning lines 38, a ratio DE₁ of the conductive mesh 46 disposed to total areal dimensions of the scanning lines 38 (wiring density DE₁) is 50% to 80%.

For example, in the case where the conductive mesh 46 is formed by intersecting linear conductive wires, it is desirable to adjust an interval d₁ between two conductive wire intersections I that are adjacent to each other in a direction orthogonal to the scanning lines 38 within a range from 10 μm to 200 μm, and to adjust the wiring width within a range from 6 μm to 30 μm. An integer multiple of the interval d₁ equals the pitch between two adjacent pixels 10.

The conductive mesh 46 is also placed in a portion above the control lines 42 while being electrically insulated from the control lines 42. The conductive mesh 46 in this portion is disposed such that a ratio DE₂ of the conductive mesh 46 disposed to the total areal dimensions of the control lines 42 (wiring density DE₂) is smaller than the wiring density DE₁, which is the density of the conductive mesh 46 disposed in the portions above the thin-film transistors and above the scanning lines 38. In short, the wiring densities DE₁ and DE₂ have a relation expressed by DE₁>DE₂.

For the portion of the conductive mesh 46 that is placed above the region where the control lines 42 are disposed, it is desirable to adjust an interval d₂ between two conductive wire intersections I that are adjacent to each other in the direction orthogonal to the scanning lines 38 within, for example, a range from 40 μm to 200 μm, and to adjust the wiring width within, for example, a range from 4 μm to 30 μm.

The interval between two conductive wire intersections I is larger in the region where the control lines 42 are disposed than in the region where the scanning lines 38 are disposed. In short, the intervals d₁ and d₂ satisfy a relation d₁<d₂. In this embodiment, the interval d₁ in the direction orthogonal to the scanning lines 38 is equal to an interval D between two adjacent scanning lines 38.

If the control lines 42 and the conductive mesh 46 intersect at more points, a parasitic capacitance between the control lines 42 and the conductive mesh 42 increases, causing a data delay in the control lines 42. In the control lines 42 in particular, the delay of an output signal due to a parasitic capacitance is larger than in the flip-flops 44 and the scanning lines 38. By keeping the areal dimensions of intersections between the control lines 42 and the conductive mesh 46 small as illustrated in FIG. 3, the parasitic capacitance formed between the control lines 42 and the conductive mesh 46 is reduced. Therefore, a data delay is consequently prevented, and a countermeasure against static electricity is put into effect.

According to this embodiment, a countermeasure against static electricity is taken by placing the conductive mesh 46 above the thin-film transistors (a part of the flip-flops 44) and the scanning lines 38. The operational stability of the scanning circuit 40 is also accomplished in this embodiment because the conductive wires are not parallel to the scanning lines 38 and the parasitic capacitance is thus kept small.

FIG. 4 is a vertical sectional view illustrating a modification example of the display device of FIG. 2. In the example of FIG. 2, the third insulating film 30 is formed in the scanning circuit 40 as well. However, when the third insulating film 30 is formed from an organic material such as a resin, an adhesive for bonding a not-shown sealing plate exhibits weak adhesion. In the modification example of FIG. 4, the third insulating film 30 is therefore not formed in the scanning circuit 40 and a conductive mesh 146 is formed on the second insulating film 28. The not-shown sealing plate is bonded to the second insulating film 28 in this case. Forming the second insulating film 28 from an inorganic material secures strong adhesion between the second insulating film 28 and the adhesive.

The present invention is not limited to the embodiment described above, and is receptive of various modifications. For instance, the structure described in the embodiment can be replaced with a structure that is practically the same as the structure of the embodiment, a structure that has the same effects, or a structure that can accomplish the same object.

What is claimed is:

1. A display device, comprising:
a display area which comprises a plurality of pixels;
a plurality of data lines for supplying a data signal to the plurality of pixels;
a plurality of scanning lines to which a scanning signal for selecting a group of pixels out of the plurality of pixels is input;
control lines to which a pulse signal is supplied to select one of the plurality of scanning lines to which the scanning signal is input;
a scanning circuit which comprises transistors controlled with the pulse signal, the scanning circuit being connected to the plurality of scanning lines and being disposed outside the display area; and
a conductive mesh including a plurality of conductive wires running in intersecting directions to have a plurality of intersections,
wherein the conductive mesh is placed above the transistors and the plurality of scanning lines except the display area, under a state in which the conductive mesh is electrically insulated from the transistors and the plurality of scanning lines, and
wherein, above the plurality of scanning lines, the plurality of conductive wires constituting the conductive mesh intersect each other three-dimensionally in a manner that does not make the plurality of conductive wires parallel to the plurality of scanning lines.

2. The display device according to claim 1, wherein:
the conductive mesh comprises a portion that is located above the control lines and that is electrically insulated from the control lines; and
in the portion, an interval between every two of the plurality of intersections of the plurality of conductive wires, the every two of the plurality of intersections being adjacent to each other in a direction orthogonal to the plurality of scanning lines, is wider than in portions of the conductive mesh that are located above the transistors and above the plurality of scanning lines.

3. The display device according to claim 1, wherein, at a portion of the conductive mesh that is located above the plurality of scanning lines, an integer multiple of an interval between every two of the plurality of intersections of the plurality of conductive wires, the every two of the plurality of intersections being adjacent to each other in a direction orthogonal to the plurality of scanning lines, is equal to a pitch between every two of the plurality of pixels that are adjacent to each other.

4. The display device according to claim 2, wherein, at a portion of the conductive mesh that is located above the plurality of scanning lines, an integer multiple of an interval between every two of the plurality of intersections of the plurality of conductive wires, the every two of the plurality of intersections being adjacent to each other in a direction orthogonal to the plurality of scanning lines, is equal to a pitch between every two of the plurality of pixels that are adjacent to each other.

5. The display device according to claim 1,
wherein the display device comprises an organic electroluminescence display device,
wherein the display device further comprises a pixel electrode disposed in each of the plurality of pixels, and
wherein the conductive mesh is formed on the same layer level as the pixel electrode.

6. The display device according to claim 1, wherein the conductive mesh is connected to one of a power source potential of the display device, a reference potential, and a ground potential.

7. The display device according to claim 1, wherein, at a portion of the conductive mesh that is located above the plurality of scanning lines, a ratio DE₁ of the conductive mesh disposed to total areal dimensions of the plurality of scanning lines is 50% to 80%.

8. The display device according to claim 7, wherein, at a portion of the conductive mesh that is located above the control lines, a ratio DE₂ of the conductive mesh disposed to total areal dimensions of the control lines is smaller than the ratio DE₁.
